(19) United States
(12) Patent Application Publication
(10) Pub. No.: US 2019/0390828 A1
(43) Pub. Date: Dec. 26, 2019

(54) Method and Apparatus for Lighting

(71) Applicant: Irwin Kotovsky, Pittsburgh, PA (US)

(72) Inventor: Irwin Kotovsky, Pittsburgh, PA (US)

(21) Appl. No.: 16/440,545

(22) Filed: Jun. 13, 2019

Related U.S. Application Data
(60) Provisional application No. 62/687,975, filed on Jun. 21, 2018.

(51) Int. Cl. F21S 8/06; F21V 23/02; F21V 13/04; F21V 21/008; F21V 23/00

(52) U.S. Cl. CPC F21S 8/065; F21V 23/02; F21S 8/061; F21Y 2115/10; F21V 21/008; F21V 23/001; F21V 13/04

(57) ABSTRACT

A lighting system having a transformer and a gripper. The lighting system has a lighting assembly having a light transmission element and an LED engaged and attached to the light transmission element. The light transmission element is made of a material that is transparent to light and which is lit by the LED. The lighting system has a suspension electrical wire electrically connected to the LED and extending from the gripper. The lighting assembly suspended from the gripper by way of the suspension electrical. The gripper holding the suspension electrical wire and attaching the suspension electrical wire to an object. The transformer provides power to the LED through the suspension electrical wire to which it is electrically connected by another electrical wire. A lighting assembly. A method for lighting

### CROSS-REFERENCE TO RELATED APPLICATIONS

This is a non-provisional of U.S. provisional application Ser. No. 62/687,975 filed Jun. 21, 2018, incorporated by reference herein.

### FIELD OF THE INVENTION

The present invention is related to a lighting system using transparent rods and LEDs. (As used herein, references to the “present invention” or “invention” relate to exemplary embodiments and not necessarily to every embodiment encompassed by the appended claims.) More specifically, the present invention is related to a lighting system using transparent rods and LEDs that are configured into a chandelier.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Lighting, in and of itself, provides an extremely important function for the day to day operation of just about everything. However, besides the functional aspect of lighting, there is also an anesthetic aspect to lighting. Light can be used to create an ambience that is also very pleasing to the eye and make a location attractive. It is an engineering challenge and an art to be able to meld the functionality of light with its aesthetic aspects to create a desirable and effective lighting system.

### BRIEF SUMMARY OF THE INVENTION

The present invention pertains to a lighting system. The lighting system comprises a transformer. The lighting system comprises a gripper. The lighting system comprises a lighting assembly having a light transmission element with a recess and an LED disposed in the recess and attached to the light transmission element. The light transmission element is made of a material that is transparent to light in which is lit by the LED. The lighting system comprises a suspension electrical wire electrically connected to the LED and extending from the gripper. The lighting assembly suspended from the gripper by way of the suspension electrical. The gripper holding the suspension electrical wire and attaching the suspension electrical wire to an object. The transformer provides power to the LED through the suspension electrical wire to which it is electrically connected by another electrical wire.

The present invention pertains to a lighting assembly. The lighting assembly comprises a light transmission element with a recess. The lighting assembly comprises an LED disposed in the recess and attached to the light transmission element, the light transmission element made of a material that is transparent to light in which is lit by the LED.

The present invention pertains to a method for lighting. The method comprises the steps of attaching a gripper to a canopy. There is the step of suspending a lighting assembly from the gripper by way of a suspension electrical wire that is electrically connected to an LED disposed in a recess of a light transmission element and attached to the light transmission element. The light transmission element is made of a material that is transparent to light in which is lit by the LED.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a side view of a lighting system of the present invention with a plurality of lighting assemblies having an LED and light transmission element suspended from an electric suspension wire attached by a cable gripper to a canopy.

FIG. 2 is an elevation view of the lighting system.

FIG. 3 is a plan view of the lighting system.

FIG. 4 shows the lighting assembly with an LED module and a glass element suspended from a canopy.

FIG. 5 shows a lighting assembly with the LED module secured in a recess in a glass rod by setscrews that extend through the glass rod and into the LED module.

FIG. 6 shows another embodiment of a lighting assembly as described in FIG. 5, but with the lens disposed at the base of a conical shaped reflector that is positioned about the bottom of the LED module where the light is emitted from the LED module.

FIGS. 7 and 8 show a side and overhead view, respectively, of the light transmission element which has a hexagonal shape.

FIGS. 9 and 10 show a side and overhead view, respectively of a light transmission element that is hexagonal shaped made of glass having air bubbles.

FIG. 11 is an elevation view of a plurality of lighting assembles in staggered height formation hanging from a canopy.

FIG. 12 is a side view of the plurality of lighting assemblies of FIG. 11.

FIG. 13 is a plan view of the plurality of lighting assemblies of FIG. 11.

FIG. 14 is a plan view of another embodiment of a plurality of light assemblies hanging in staggered fashion from a canopy.

FIG. 15 is an elevation view of the embodiment of a plurality of light assemblies of FIG. 14.

FIG. 16 is a side view of the embodiment of a plurality of light assemblies of FIG. 14.

FIG. 17 is an elevation view of light assemblies forming a chandelier.

FIG. 18 is a side view of a portion of the chandelier of FIG. 17.

FIG. 19 is a plan view of the chandelier of FIG. 17.

FIG. 20 is an elevation view of another embodiment of a chandelier.

FIG. 21 is a side view of a portion of the chandelier of FIG. 20.

FIG. 22 is a plan view of light assemblies forming the chandelier of FIG. 20.

FIG. 23 is an elevation view of another embodiment of a chandelier.

FIG. 24 is a side view of a portion of the chandelier of FIG. 23.

FIG. 25 is a plan view of light assemblies forming the chandelier of FIG. 23.

FIG. 26 is an elevation view of yet another embodiment of a chandelier.

FIG. 27 is a side view of a portion of the chandelier of FIG. 26.

FIG. 28 is a plan view of light assemblies forming the chandelier of FIG. 27.

### DETAILED DESCRIPTION OF THE INVENTION

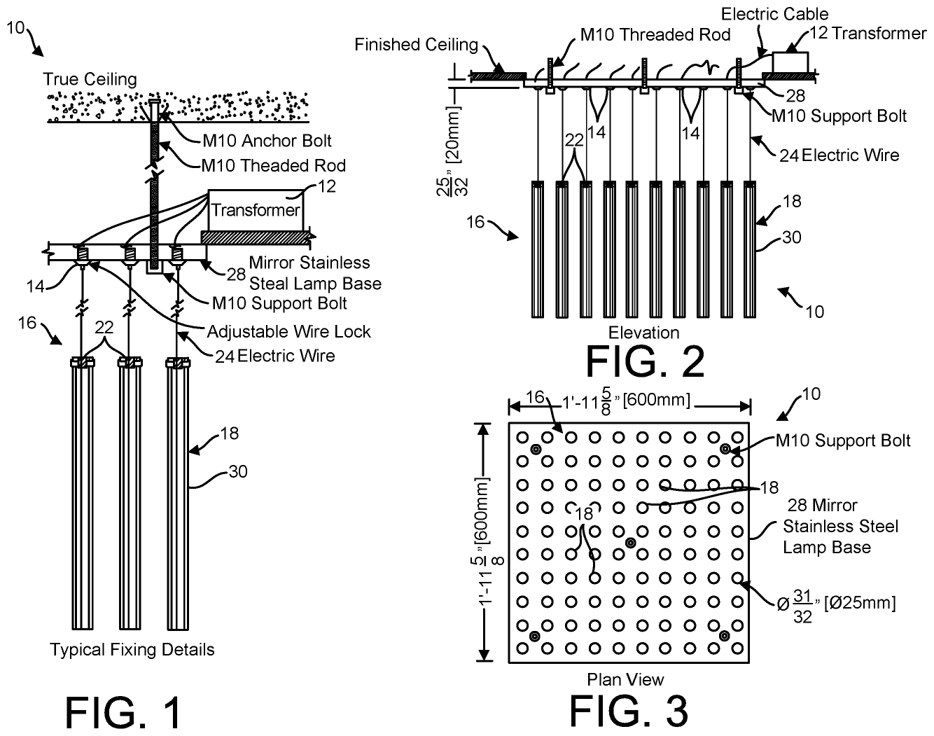

Referring now to the drawings wherein like reference numerals refer to similar or identical parts throughout the several views, and more specifically to FIGS. 1-4 thereof, there is shown a lighting system 10. The lighting system 10 comprises a transformer 12. The lighting system 10 comprises a gripper 14. The lighting system 10 comprises a lighting assembly 16 having a light transmission element 18 with a recess 20 and an LED 22 disposed in the recess 20 and attached to the light transmission element 18. The light transmission element 18 is made of a material that is transparent to light in which is lit by the LED 22. The light transmission element 18 is preferably at least 6 inches long, and typically between 6 inches and 24 inches long, such as 6 inches, 8 inches, 10 inches, 12 inches, 14 inches, 16 inches or 18 inches. The LED 22 may also be disposed on top of the light transmission element 18 and in contact with the top of the light transmission element 18 and engaged to be coupled with the light transmission element 18 so light emitted from the LED 22 is transmitted through the light transmission element 18.

Alternatively, the LED 22 may be engaged with the light transmission element 18, such as by being placed on top of and in contact with the transmission element 18 and glued to it. In this way, no recess 20 is present or needed to receive the LED 22.

The lighting system 10 comprises a suspension electrical wire 24 electrically connected to the LED 22 and extending from the gripper 14. The lighting assembly 16 is suspended from the gripper 14 by way of the suspension electrical wire 24. The gripper 14 holds the suspension electrical wire 24 and attaches the suspension electrical wire 24 to an object 26, such as a wall or ceiling. The transformer 12 provides power to the LED 22 through the suspension electrical wire 24 to which it is electrically connected by another electrical wire. The transformer 12 may be located above the ceiling, so it is not visible and the LED 22 and the light transmission element 18 is below the ceiling to provide light to the room or structure it is hanging in.

The light transmission element 18 may be a transparent rod 30. The transparent rod 30 may be either cylindrical, or multisided; and is either hollow or solid. The transparent rod 30 may be a first glass rod 32. The first glass rod 32 may have a recess 20 in which the LED 22 is disposed. The system 10 may include a lens 34 disposed in the recess 20 under the LED 22. The system 10 may include a reflector 36 disposed in the recess 20 above the lens 34 and below the LED 22. The first glass rod 32 may be solid and has bubbles 46. The light transmission element 18 with the LED 22 may be hanging freely from the suspension electrical wire 24, separate and independent of anything else. If used with a chandelier 40, as described below, a plurality of separate and independent lighting assemblies 16 are used, which may or may not contact each other along their sides.

The first glass rod 32 may be either clear, frosted or multicolored. The lighting assembly 16 may include a second glass rod 38 that has a length which is different than a length of the first glass rod 32. The gripper 14 may include a ceiling mount or a pendant mount or a wall mount or a floor lamp or a table lamp. The lighting assembly 16 may be a chandelier 40. The first glass rod 32 may have a top portion 42 having the recess 20 and the LED 22 and a separate bottom portion 44 attached to the top portion 42 at a seam 54. The top portion 42 may be glass without bubbles 46 and the bottom portion 44 may be glass with bubbles 46. The lighting assembly 16 may include a plurality of additional glass rods.

The present invention pertains to a lighting assembly 16. The lighting assembly 16 comprises a light transmission element 18 with a recess 20. The lighting assembly 16 comprises an LED 22 disposed in the recess 20 and attached to the light transmission element 18, the light transmission element 18 made of a material that is transparent to light in which is lit by the LED 22.

The present invention pertains to a method for lighting. The method comprises the steps of attaching a gripper 14 to a canopy 28. There is the step of suspending a lighting assembly 16 from the gripper 14 by way of a suspension electrical wire 24 that is electrically connected to an LED 22 disposed in a recess 20 of a light transmission element 18 and attached to the light transmission element 18. The light transmission element 18 is made of a material that is transparent to light in which is lit by the LED 22.

FIGS. 1-3 show a system 10 with a plurality of lighting assemblies having an LED 22 and light transmission element 18 suspended from an electric suspension wire 24 attached by a cable gripper 14 to a canopy 28. Here, the canopy 28 is a mirror stainless steel lamp base to which the cable grippers are threaded in place or clamped in place, as is well known in the art. Each electric suspension wire 24 is connected to a transformer 12 disposed above the ceiling. An anchor bolt 50 can be embedded in the true ceiling with a threaded rod extending down from the anchor bolt 50 to hold the base in place.

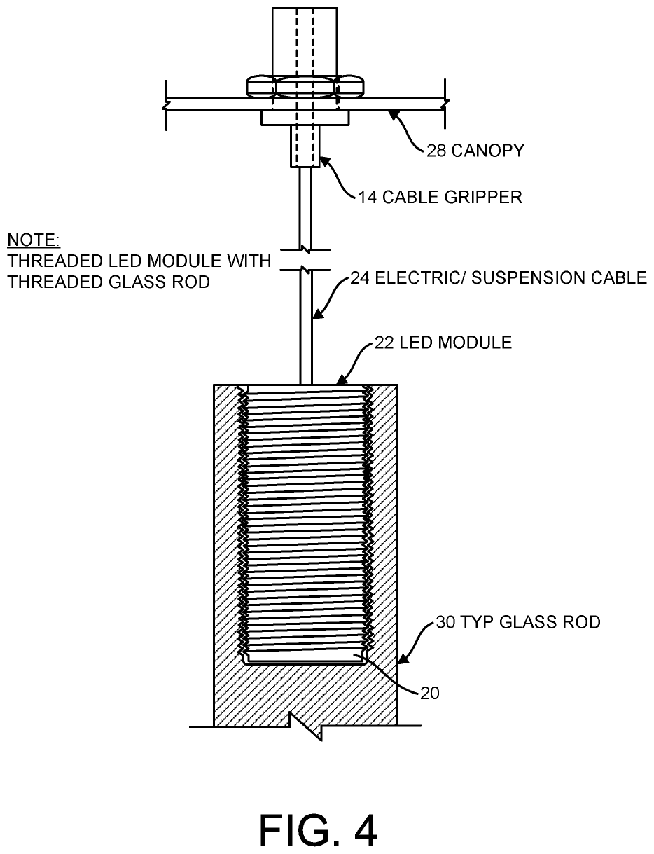

FIG. 4 shows the lighting assembly 16 with an LED 22 module and a glass rod 32 suspended from a canopy 28, such as a roof or ceiling or layer, suspended from the roof or below the roof. The electric suspension wire 24 or cable is attached to the canopy 28 with a cable gripper 14, which is well known in the art. The lighting assembly 16 hangs freely by the suspension wire 24.

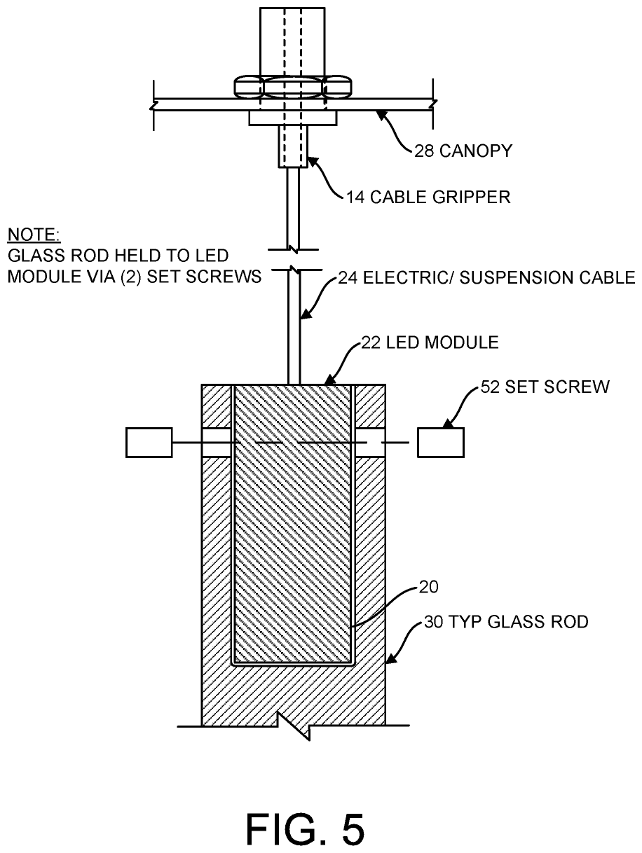

FIG. 5 shows a lighting assembly 16 with the LED 22 module secured in a recess 20 in a glass rod 48 by setscrews 52 that extend through the glass rod 48 and into the LED 22 module.

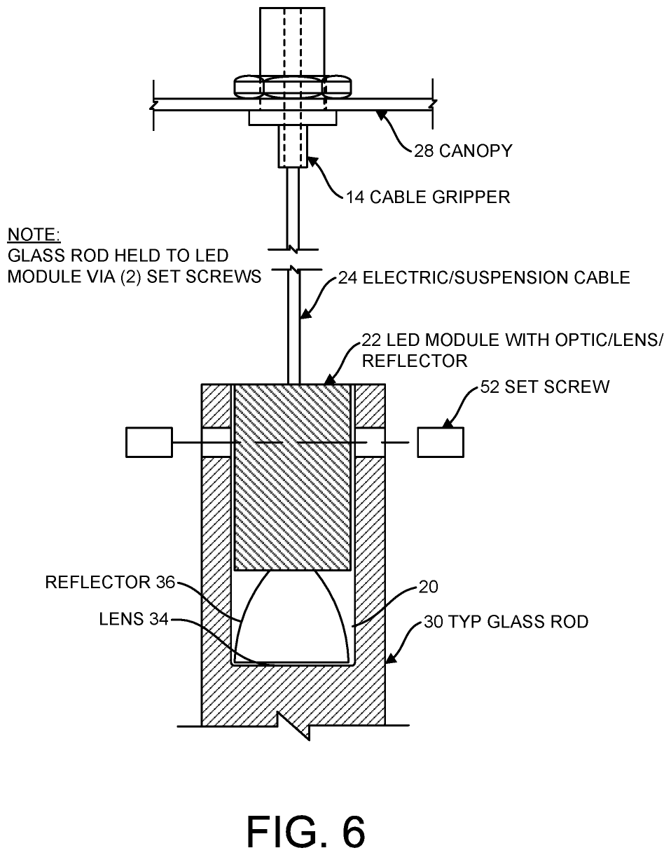

FIG. 6 shows another embodiment of a lighting assembly 16 as described in FIG. 5, but with the lens 34 disposed at the base of a conical shaped reflector 36 that is positioned about the bottom of the LED 22 module where the light is emitted from the LED 22 module. The reflector 36 and lens 34 serve to focus the light emitted from the LED 22 module. The reflector 36 and lens 34 are disposed in the recess 20 below where the LED 22 module is disposed in the recess 20, with adequate space in the recess 20 for the reflector 36 and lens 34.

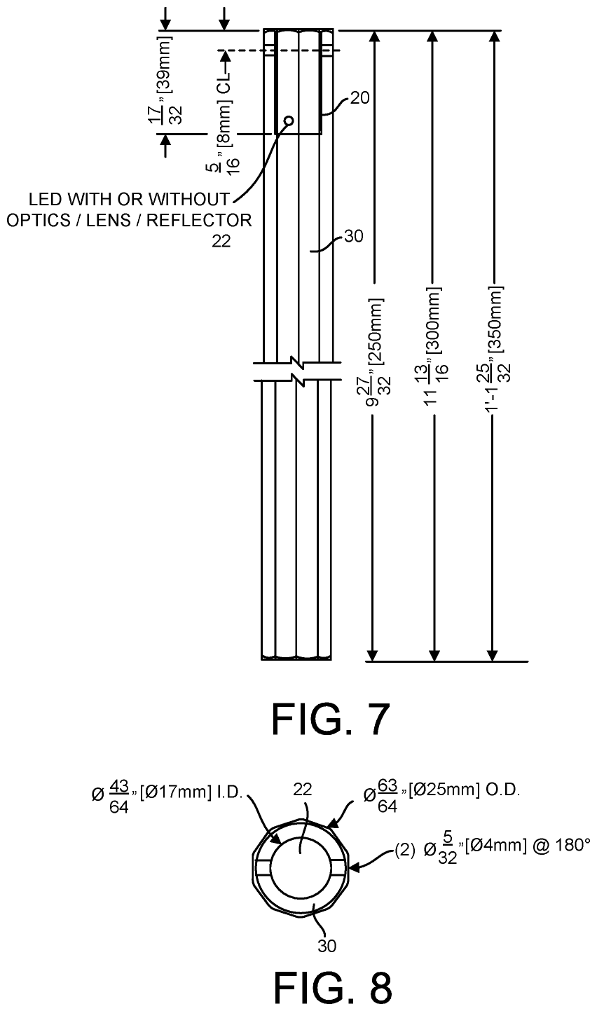

FIGS. 7 and 8 show the light transmission element 18 which has a hexagonal shape.

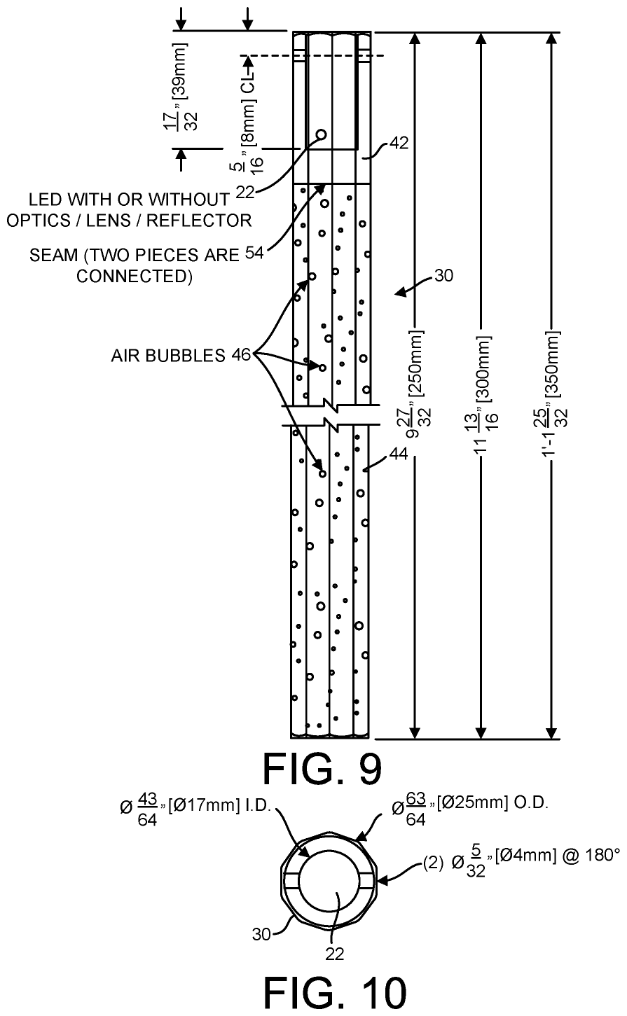

FIGS. 9 and 10 show a light transmission element 18 that is hexagonal shaped made of glass having air bubbles 46.

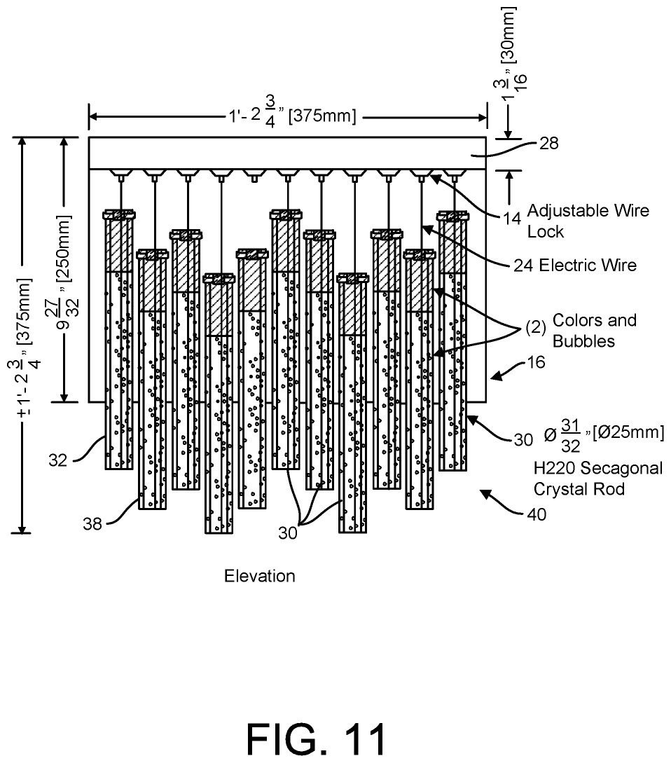

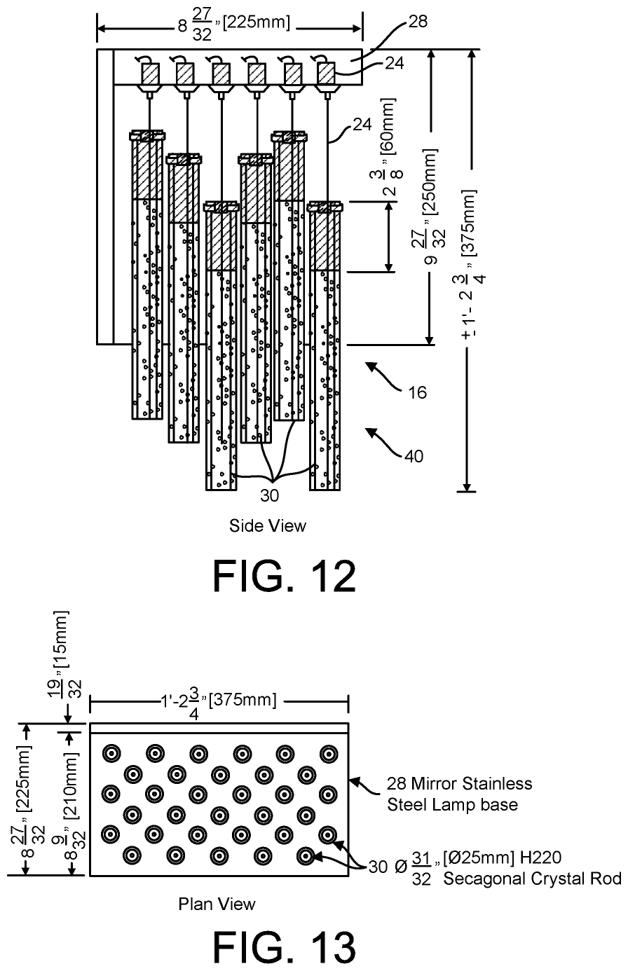

FIGS. 11-13 show a plurality of lighting assembles in staggered height formation hanging from a canopy 28. The light transmission element 18 has a first color disposed at the top of the light transmission element 18 and a second different color than the first color disposed at the bottom of the light transmission element 18. Here, the light transmission elements 18 are crystal rods.

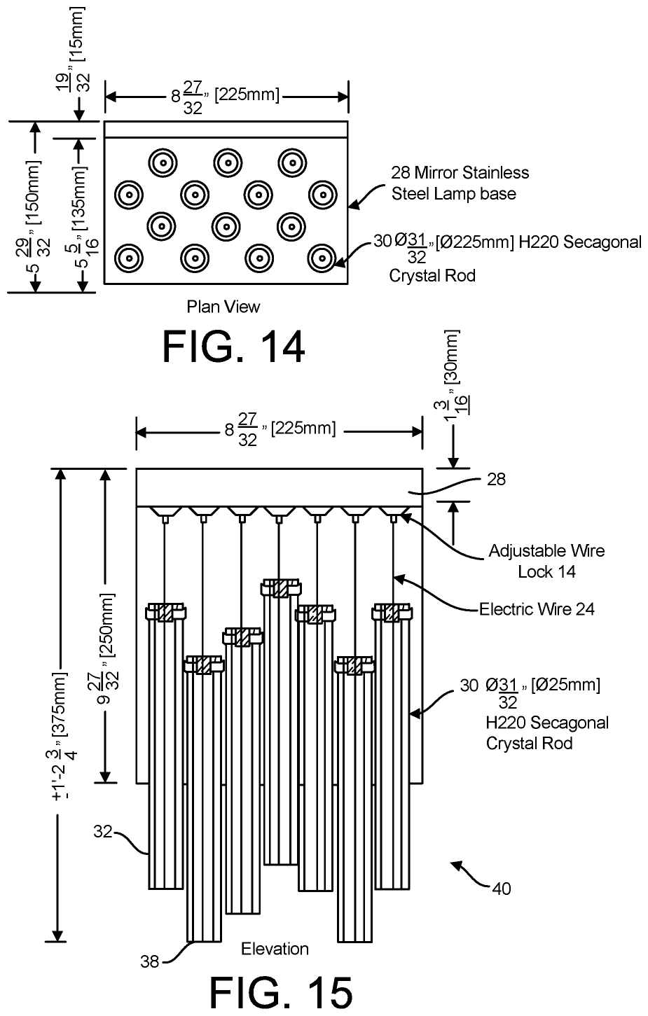

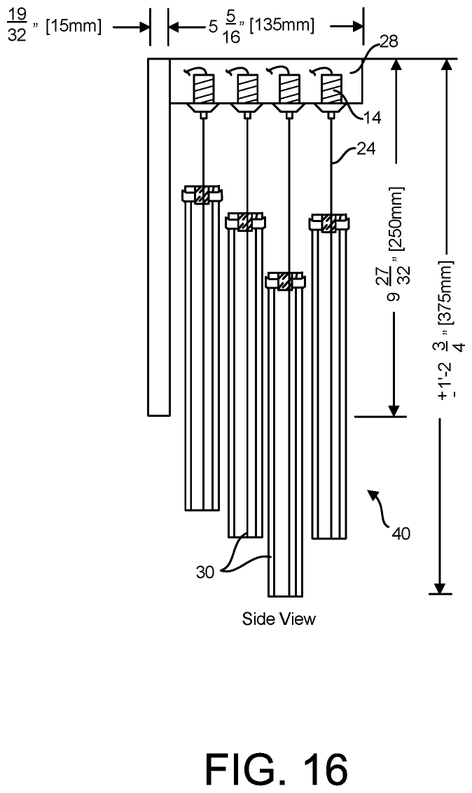

FIGS. 14-16 show another embodiment of a plurality of light assemblies hanging in staggered fashion from a canopy 28, all powered from a transformer 12 to which they are all connected through electrical wiring, and individually hanging from their own electrical suspension wire 24.

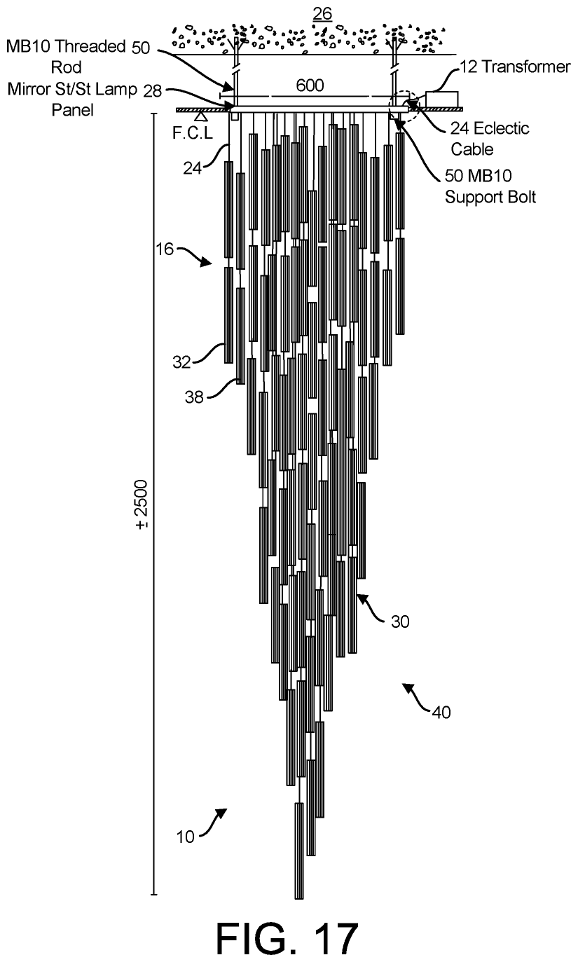

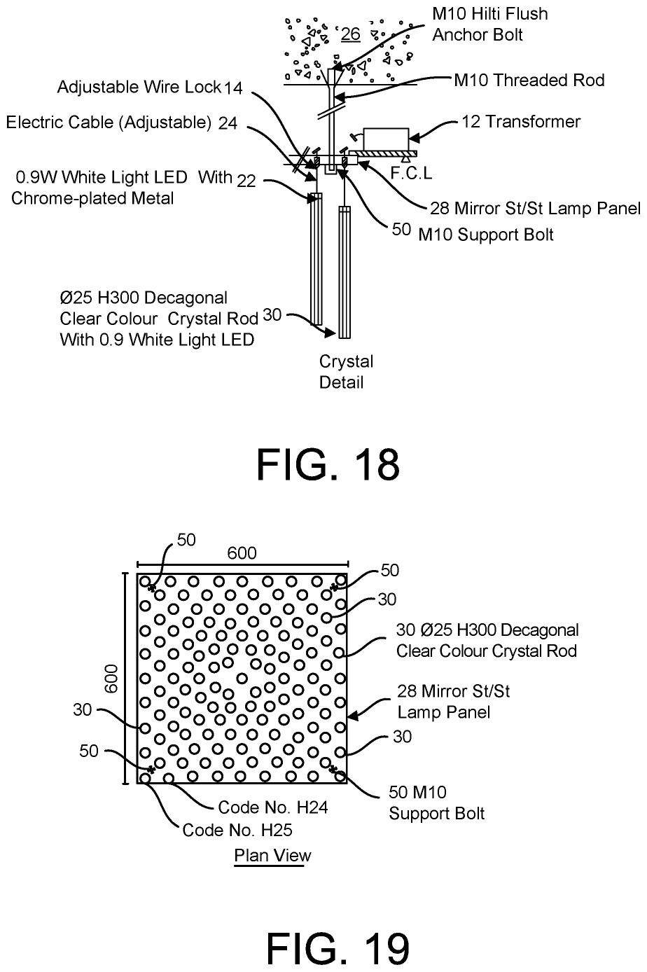

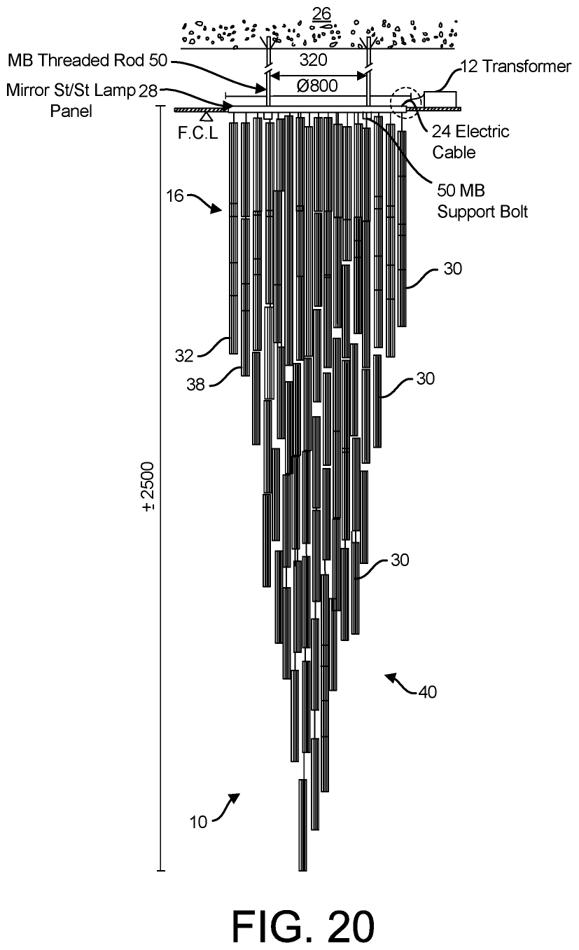

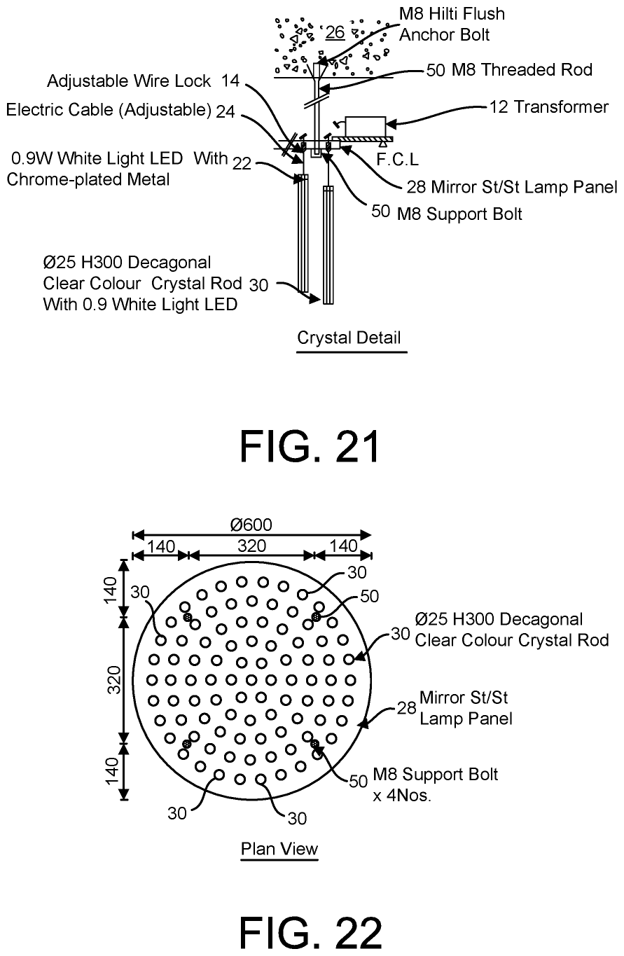

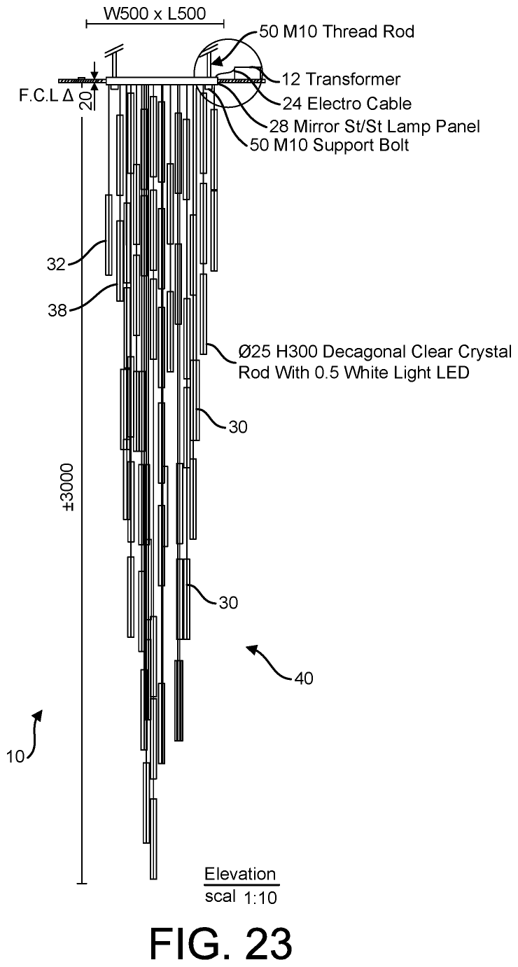

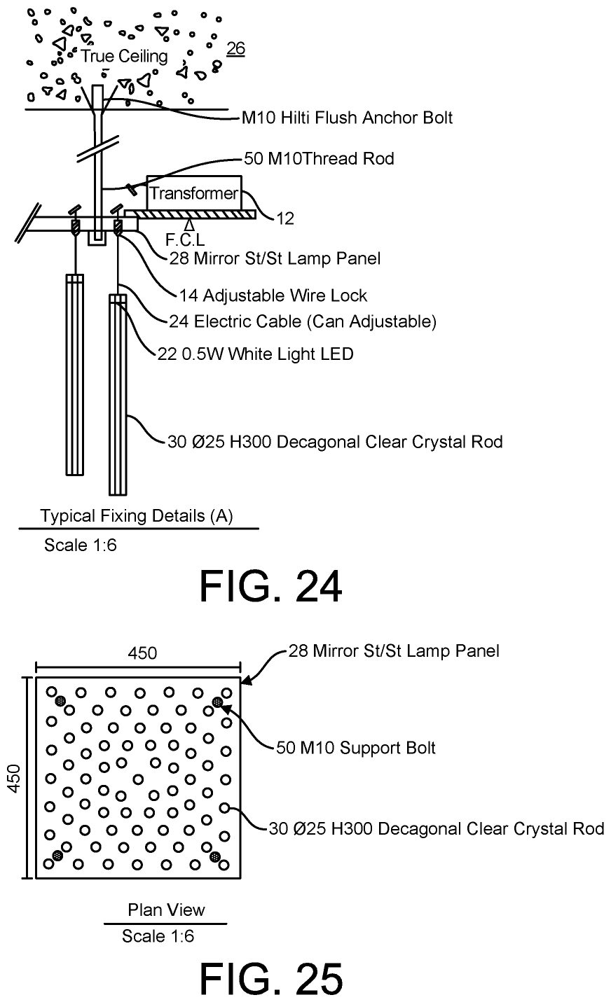

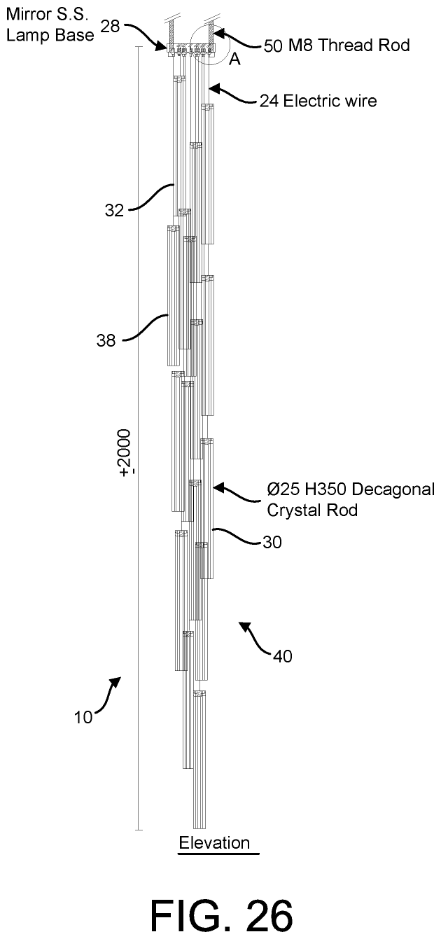

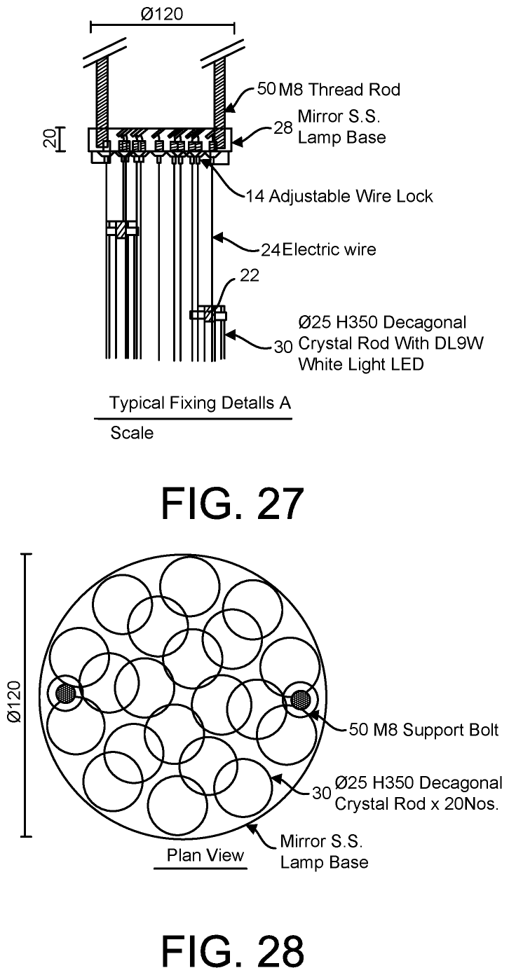

FIGS. 17-28 show various embodiments of the light assemblies forming chandeliers 40. In all cases, the lighting assemblies are those described in FIGS. 4-10 above.

The lighting assembly 16 can use the following Mounting:

Ceiling

Pendant

Wall

Floor lamp

Table lamp

The light transmission element 18 may be comprised of:

cylindrical, triangular, octagonal, hexagonal, five sided, and can be Solid or Hollow (If solid can contain air bubbles 46)

Can be tubular as well as cylindrical or any geometric configuration

Conical (tapered)

Glass can also be made from slabs

Slabs can be solid or hollow

Glass pieces can be segmented and held together with invisible adhesive, pins, screws or other

Available in clear frosted or colors

Colors can be mixed

LED 22 sources can be provided for each element (rod, tub, cylinder, cone etc.)

The LED 22 can be integral, embedded to the glass or external

Each rod can be illuminated by its own LED 22 or one LED 22 can be used for a group of transmission elements 18.

Sizes and shapes of the transmission elements 18 can be mixed.

Reflectors 36 and/or lenses 34 can be provided for each element 18 or groups or clusters of elements 18.

The reflectors 36 and/or lenses 34 can be plastic, silicone, glass or of other materials. They can be clear or frosted and have fixed beam angles or adjustable beam angles.

Beam angles can be controlled manually or electronically with remote controls, wall switches, or smart devices. A small motor with a receiver to receive the remote signals may be disposed in the recess and engaged with the reflector 36 or lens 34, or both, to move them to a desired position based on the signals received by the receiver.

LEDs 22, if external to the glass, can be attached with adhesive or external brackets to the glass and be connected to cables visible or invisible, coated and insulated or uncoated.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A lighting system comprising:
a transformer;
a gripper;
a lighting assembly having a light transmission element with a recess and an LED disposed in the recess and attached to the light transmission element, the light transmission element made of a material that is transparent to light in which is lit by the LED; and
a suspension electrical wire electrically connected to the LED and extending from the gripper, the lighting assembly suspended from the gripper by way of the suspension electrical wire, the gripper holding the suspension electrical wire and attaching the suspension electrical wire to an object.

2. The system of claim 1 wherein the light transmission element is a transparent rod.

3. The system of claim 2 wherein the transparent rod is either cylindrical, or multisided; and is either hollow or solid.

4. The system of claim 3 wherein the transparent rod is a first glass rod.

5. The system of claim 4 wherein the first glass rod has the recess in which the LED is disposed.

6. The system of claim 5 including a lens disposed in the recess under the LED.

7. The system of claim 6 including a reflector disposed in the recess above the lens and below the LED.

8. The system of claim 7 wherein the first glass rod is solid and has bubbles.

9. The system of claim 8 wherein the first glass rod is either clear, frosted or multicolored.

10. The system of claim 9 wherein the lighting assembly includes a second glass rod that has a length which is different than a length of the first glass rod.

11. The system of claim 10 wherein the gripper includes a ceiling mount or a pendant mount or a wall mount or a floor lamp or a table lamp.

12. The system of claim 11 wherein the lighting assembly is a chandelier.

13. The system of claim 12 wherein the first glass rod has a top portion having the recess and the LED and a separate bottom portion attached to the top portion at a seam.

14. The system of claim 13 wherein the top portion is glass without bubbles and the bottom portion is glass with bubbles.

15. The system of claim 14 wherein the lighting assembly includes a plurality of additional glass rods.

16. A lighting assembly comprising:
a light transmission element with a recess; and
an LED disposed in the recess and attached to the light transmission element, the light transmission element made of a material that is transparent to light in which is lit by the LED.

17. A method for lighting comprising the steps of:
attaching a gripper to a canopy; and
suspending a lighting assembly from the gripper by way of a suspension electrical wire that is electrically connected to and LED disposed in a recess of a light transmission element and attached to the light transmission element, the light transmission element made of a material that is transparent to light in which is lit by the LED.
